(19) United States
(12) Patent Application Publication
(10) Pub. No.: US 2012/0090032 A1
(43) Pub. Date: Apr. 12, 2012

(54) Webtextbooks

(76) Inventor: Victor Trinklein, Muttontown, NY (US)

(21) Appl. No.: 12/899,351

(22) Filed: Oct. 6, 2010

(51) Int. Cl. G06F 21/00

(52) U.S. Cl. 726/26

(57) ABSTRACT

A distribution system for viewing an electronic book may include A content provider to obtain and provide the electronic book, a distribution center to distribute the electronic book from the content provider, and a predetermined number of home centers to view the electronic book by a predetermined number of users. N may be the number of simultaneous users viewing a single electronic book; and no more than n is the number of purchased electronic books from the content provider. The number of users registered to view the electronic book may be greater than n, and if the user view the electronic book for more than a predetermined period of time than that user may be inactivated from viewing the electronic book. The user may view the electronic book at the content provider, and the electronic book may be downloaded to a server of the distribution center or a viewership account may be created to be viewed by the user.

### FIELD OF THE INVENTION

This invention is directed to an electronic book unit having one or more electronic books. More specifically, the invention is an improved method for purchasing electronic books.

### BACKGROUND

Sparked by the concept of an information superhighway, a revolution will take place in the distribution of books. Not since the introduction of Gutenberg's movable typeset printing has the world stood on the brink of such a revolution in the distribution of text material. The definition of the word “book” will change drastically in the near future.

### SUMMARY

A distribution system for viewing an electronic book may include A content provider to obtain and provide the electronic book, a distribution center to distribute the electronic book from the content provider, and a predetermined number of home centers to view the electronic book by a predetermined number of users.

N may be the number of simultaneous users viewing a single electronic book; and no more than n is the number of purchased electronic books from the content provider.

The number of users registered to view the electronic book may be greater than n, and if the user remained idle while viewing the electronic book for more than a predetermined period of time than that user may be inactivated from viewing the electronic book.

The user may view the electronic book at the content provider, and the electronic book may be accessed via an established etextbook rental account or downloaded to a server of the distribution center to be viewed by the user.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a flow chart of the sign in process of the present invention;

FIG. 2a 2b, 2c illustrates an another flow chart of the operation of the present invention;

FIG. 3 shows an electronic book distribution system;

FIG. 4 shows components of an electronic book distribution system;

FIG. 5 shows an embodiment of an electronic book selection and delivery system.

### DETAILED DESCRIPTION

The present invention includes a content provider 110 provide content to the distribution center 120 which in turn may provide the content to the user at a home system 258 which may include locations of the user through the use of a mobile/wireless device. The content provider 110 receives textual material from outside sources such as publishers, newspapers, and on-line services. Alternately, the outside sources may maintain electronic books at an Internet web site. The content provider 102 may convert textual and graphical material to digital format, or may contract with another vendor to provide this service. The content provider 102 may receive the textual and graphical material in various digital formats and may convert the textual material to a standard compressed format for storage. In so doing, the operations center 250 may create a pool of textual material that is available to be delivered to the home system 258. The textual material may be grouped by books or titles for easy access.

As used herein, “electronic book” means textual or graphical information such as contained in any novels, encyclopedias, articles, magazines or manuals and may include an etextbook. The term “title” may represent the actual title assigned by an author to a book, or any other designation indicating a particular group, portion, or category of textual information

Many analog and digital distribution systems 208, or other telecommunications systems, can be used with the delivery system 200, such as a cable television distribution system, a broadcast television distribution system, video distributed over telephone systems, distribution from the Internet, direct satellite broadcast distribution systems, and other wired and wireless distribution systems.

The billing and collection system 278 may be co-located with the operations center 250 or located remote from the operations center 250. The billing and collection system 278 is in communication with the home system 258 via telephone-type communication systems (for example 274). Any of a number of telephone type communication systems, such as, a cellular system, will operate with the billing and collection system 278. The billing and collection system 278 records the electronic books or portions of text that are selected or ordered by the subscriber. The collection system will charge a subscriber's credit account or bill the subscriber. In addition, the billing and collection system 278 will monitor that amount due to publishers or other outside sources 282 who have provided textual data or other services such as air time to enable the text delivery system 200 to operate.

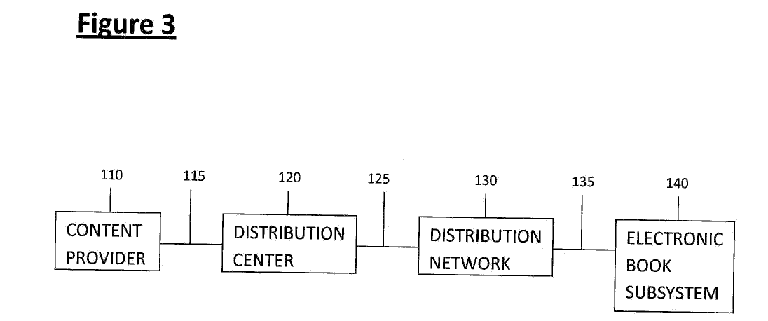

FIG. 3 shows an electronic book distribution system 100 that may be used for secure distribution of an electronic book. A content provider 110 may publish hard copy versions of books or other printed media including newspapers, magazines, and product catalogs, for example. The content provider 110 may convert printed materials to an electronic format, apply security mechanisms, and provide the electronic formatted materials to a distribution center 120, over uplink path 115. The uplink path 115 may be a wired or a wireless path. The uplink path 115 may be a telecommunications network, for example. The uplink path 115 may be a satellite relay path or a wireless telephone path. The uplink path 115 may involve providing electronic books to the distribution center on a fixed media, such as a CD-ROM, for example.

In FIG. 3, the content provider 110 and the distribution center 120 are shown as separate components of the electronic book distribution system 100. However, the content provider 110 and the distribution center 120 may be co-located. The distribution center 120 may convert printed matter into an electronic format. Alternately, the distribution center 120 may receive electronic files from an outside source, such as the content provider 110. The distribution center 120 may process and store electronic books using secure techniques.

The distribution center 120 distributes electronic books. The distribution may be, for example, over distribution path 125, distribution network 130, and distribution path 135 to an electronic book subsystem or terminal 140, which may include an electronic book viewer (not shown). The terminal may also be a television, a set top terminal, a personal computer, or similar device. An apparatus and method for the secure distribution of electronic books is disclosed in greater detail later. The distribution network 130 may be an electronic book store, an Internet web site, a wired or wireless telecommunications network, an intranet, a radio program delivery system, a television program delivery system, including cable television, satellite television broadcast, and over-the-air broadcast, for example. The electronic book distribution network 130 could include direct delivery through a mail delivery system of electronic books on a fixed media, such as a CD-ROM, for example.

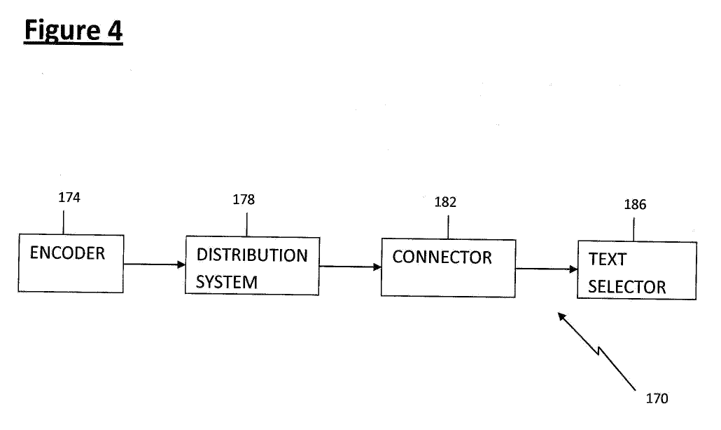

FIG. 4 shows components of an electronic book distribution system 170 using a television program delivery system to distribute electronic books. In the embodiment shown in FIG. 3, the components of the electronic book selection and delivery system 170 are an encoder 174, a distribution system 178, a connector 182, and a text selector 186. The encoder 174 places textual data on a video signal to form a composite video signal. Although the composite signal may contain only textual data, it usually carries both video and textual data. A variety of equipment and methods may be used to encode text data onto a video signal. The video distribution system 178 distributes the composite video signal from the single point of the encoder 174 to multiple locations, which have connectors 182. The connector 182 receives the digital or analog video signal from the video distribution system 178 and separates, strips or extracts the text data from the composite video signal. If necessary, the extracted text data is converted into a digital bit stream. The text selector 186 works in connection with the connector 182 to select text.

Using the connector 182 and text selector 186 combination, various methods of selecting and retrieving desired text from a composite or video signal are possible. Text may be preselected, selected as received or selected after being received and stored. One method is for the connector 182 to strip or extract all the text from the video signal and have the text selector 186 screen all the text as received from the connector 182. The text selector 186 only stores text in long term or permanent memory if the text passes a screening process described below.

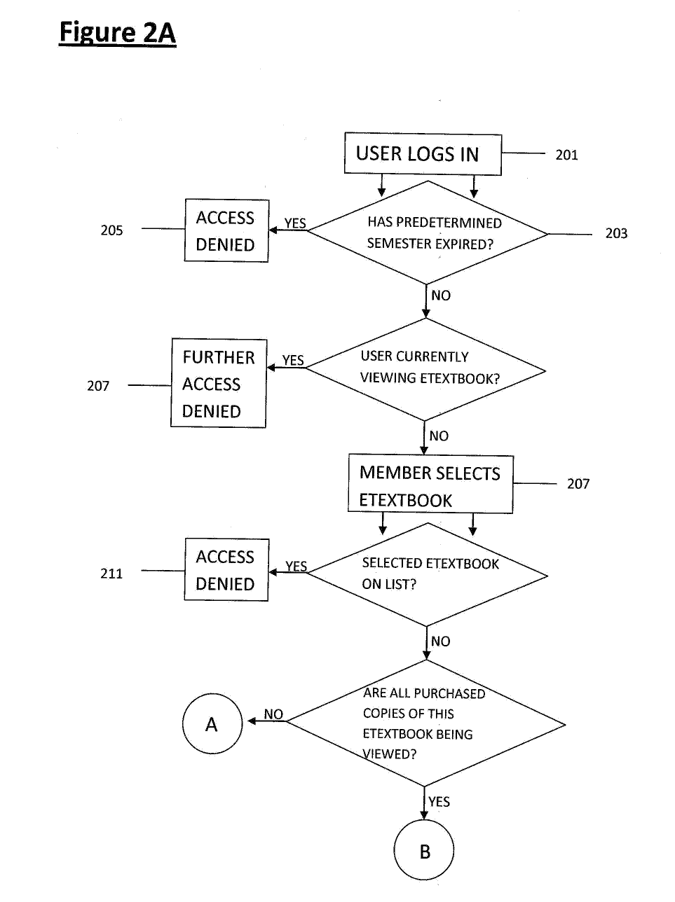

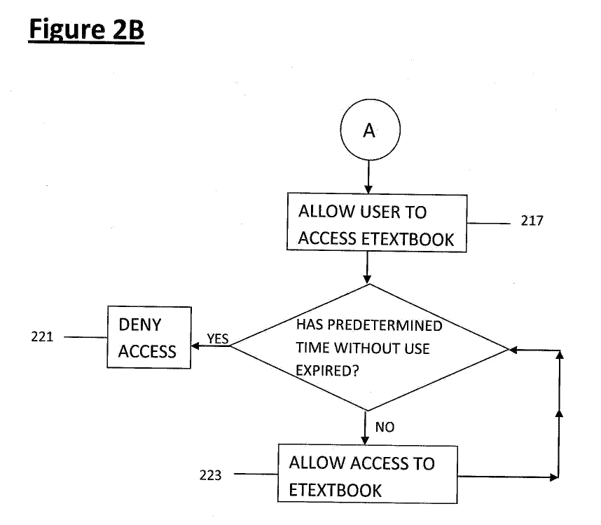

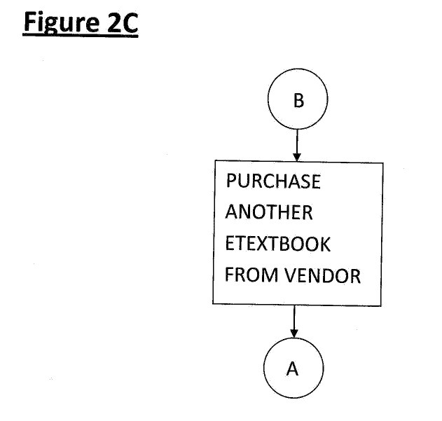

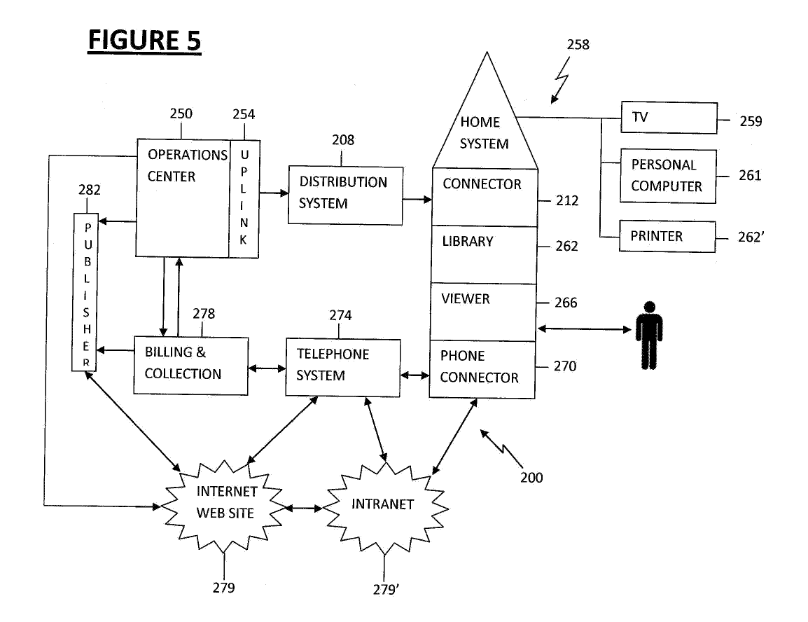

FIG. 5 shows another embodiment of an electronic book selection and delivery system 200. The delivery system 200 includes: an operations center 250 including an uplink site 254, a video distribution system 208, a home system 258 including a video connector 212, a library 262, a viewer 266, and a phone connector 270, telephone system 274, an Internet web site 279 and a billing and collection system 278. Also as shown in FIG. 2, the home system 258 may include connections to a television 259 and a personal computer 261 may be used to display menu screens, electronic books, electronic files, or any other information associated with the electronic book delivery system 200. In addition, the television 259 and the personal computer 261 may provide control functions that replicate and supplement those of the viewer 266.

The operations center 250 receives textual material from outside sources 282 such as publishers, newspapers, and on-line services. Alternately, the outside sources may maintain electronic books at the Internet web site 279. The outside sources 282 may convert textual and graphical material to digital format and apply security mechanisms, or may contract with another vendor to provide this service. The operations center 250 may receive the textual and graphical material in various digital formats and may convert the textual material to a standard compressed format for storage. In so doing, the operations center 250 may create a pool of textual material that is available to be delivered to the home system 258. The textual material may be grouped by books or titles for easy access.

The operations center 250 includes the uplink site 254 for placing the text onto a telecommunications signal in a secure fashion and sending the telecommunications signal into a distribution system. The uplink site 254 would generally include an encoder 204 (not shown in FIG. 2) to encode the text onto the telecommunications signal.

Many analog and digital video distribution systems may be used with the electronic book delivery system 200, such as cable television distribution systems, broadcast television distribution systems, video distributed over telephone systems, direct satellite broadcast distribution systems, and other wire and wireless video distribution systems. Nearly any distribution system which can deliver a telecommunications signal, including a video signal, will work with the electronic book delivery system 200. It is also possible to distribute the electronic book without using a telecommunications signal as described in the embodiments presented in the referenced related applications. Methods used for securing the distribution of materials over the electronic book delivery system 200 are presented below.

The home system 258 performs five functions: (1) connecting with a video distribution system; (2) selecting data; (3) storing data; (4) displaying data; and (5) handling transactions. An important optional function of the home system 258 is communicating using, in one embodiment, a telephone communication system 274. The home system 258 may be made up of four parts: a video connector 212 or similar type of connector for connecting with the distribution system 208, a library 262 for storing and processing, a viewer 266 for viewing menus and text and a telephone connector 270 for connecting with a telephone communications system 274. Additional embodiments are presented in the referenced related applications that address alternative communication mechanisms.

The billing and collection system 278 may be co-located with the operations center 250 or located remote from the operations center 250. The billing and collection system 278 may be in communication with the home system 258 using telephone-type communication systems (for example 274). Any of a number of communication systems as presented in the referenced related applications, such as a cellular system or the Internet, will operate with the billing and collection system 278. The billing and collection system 278 records the electronic books or portions of text that are selected or ordered by the subscriber. The collection system will charge a subscriber's credit account or bill the subscriber. In addition, the billing and collection system 278 may monitor that amount due to publishers or other outside sources 282 who have provided textual data or other services such as air time to enable the text delivery system 200 to operate.

Also shown in FIG. 5 is an intranet 279′. The intranet 279′ may be used as a part of a private distribution network for distributing and circulating electronic books. For example, a university library may use the intranet 279′ to circulate electronic books to university students and professors.

The distribution center 120 includes a system for the distribution of textbook or book material which may include the Internet to distribute the electronic book. By the operation of the system of the present invention, users such as students may be provided with an electronic book at a lower cost. The distribution center 120 may operate as a intermediary between the users and the content providers 110 which may provide an electronic book ownership. The distribution center 120 including the billing and collection system 278 may purchase the electronic book in either an online or downloadable form and the electronic book may be accessible to the users through an account access over a secured server respectively. In a manner similar to an Internet library, the server of the distribution center 120 may store the electronic books or accounts in a database which may be controlled by the distribution center 120. The electronic book may become viewable to the user through the website of the distribution center 120 in accordance with any and all mandated regulations including copyright laws. The users are registered into distribution center 120 membership via the website of the distribution center 120 and these users will have access to the electronic book for the electronic book that they have selected. The distribution center 120 may have purchased a predetermined number of electronic books and the distribution center 120 may prevent the users from viewing more than the predetermined number of electronic books. When the number of users exceeds the predetermined number of electronic books, the distribution center 120 may purchase additional electronic books in order to satisfy the needs of the users. Typically, the number of users who have registered for a particular electronic book will be far larger than the number of users to desire to view the electronic book at any one particular time. Consequently, the distribution center 120 is able to reduce the number of electronic books required for the users and consequently can reduce the cost of maintaining the number of electronic books. This savings can be shared between the distribution center 120 and the users.

The users may be restricted from viewing more than one electronic book during a time. This reduces the need for additional copies of a electronic book. The users are permitted to view a copy of the electronic book for an indefinite period. However, the distribution center 120 will automatically turn off a user after a inactivity predetermined period of time. This period of time may be adjusted in order to reduce the use of the electronic book. Once a user finishes viewing a electronic book, that electronic book will be available for use of another user.

The distribution center 120 may be a electronic book service where the user will signed up for a predetermined period of time such as a semester and may be able to view any electronic book from their textbook list at any time during the semester by checking into the website of the distribution center 120 and checking out the electronic book for their use.

The content supplier of the electronic books may include an account for each user and for each electronic book. These accounts may be registered under different e-mail addresses which may be usernames. The distribution center 120 may create and may hold the account numbers for the content supplier of the electronic book for example on a server which may serve as the a electronic book vault. Alternatively, if the electronic books were purchased in a downloadable form, then the e-mail addresses may be eliminated. Under these circumstances, there would be no need for separate accounts and the electronic book may be stored directly on a server.

The electronic books may only be purchased as they are needed. For example if 50 students subscribed for the same electronic book, the distribution center 120 would not initially purchased 50 copies of that electronic book. Instead, distribution center 120 may only purchase as many electronic books as necessary to accommodate peak traffic for that specific electronic book. For example, if 15 of the 50 users were using that electronic book at a given time, distribution center 120 may only purchase 15 copies by 15 created accounts or 15 purchased downloads of the electronic book. An additional electronic book should be purchased automatically when all of the other purchased electronic books are being currently used by other users. For example, distribution center 120 will automatically and instantaneously purchase and create a new account by using a new e-mail address and purchase the needed electronic book or simply by the required electronic book by download to satisfy the new peak traffic level reached.

The sign up process of the distribution center 120 includes the step that the user will go to the website of the distribution center 120 and optionally login or register if this is the first time of use of the website.

1. Each user may create an account with an e-mail address which may be the user name and with a password.

2. The distribution center 120 may verify the e-mail address through an activation code which may be e-mailed to the newly registered user.

The account profile page

After successfully registering and activating the user name through e-mail verification, the user will be directed to start the purchase of electronic books.

The user may create a list of electronic books which may be required for the semester (a predetermined time period). The ISBN may be used for this purpose.

The distribution center 120 may check the availability of the electronic book, and once the availability of the electronic book has been established, the results will be displayed to the user.

The results may show if the electronic book is available or not available, and if the electronic book is available, the results may show a price for the user to pay. The price may be a predetermined percentage, such as 70% of the price which may be paid by the user without the help of the distribution center 120.

The procedure may be repeated for each electronic book which may be required by the user for the semester/predetermined period of time. The total price is calculated including sales tax and the user may pay the subscription by a debit/credit information or PayPal.

A receipt may be generated which may be printed or saved.

The user may return to the profile page of the user in order to view a single electronic book from the list of electronic books. The viewing may be channeled directly from the content provider 110 but may be channeled through the website of the distribution center 120 so that the user is restricted to viewing only a single electronic book and to avoid the user changing passwords or account information. The user may close the book to end the viewing session and to return to the profile page.

The inactivity of the user may be monitored and if the inactivity time exceeds a predetermined period of time, the distribution center 120 may end the viewing session for the electronic book.

If the user activates a electronic book, then the account is inactivated for further activity until the viewing session of the electronic book is ended.

Once the user enters the viewing session of the electronic book, the electronic book is available for another user to open and view.

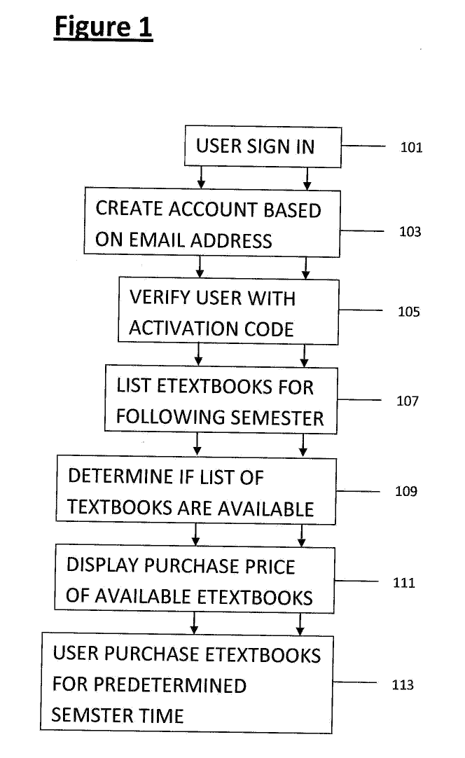

FIG. 1 illustrates a flow chart to describe the setup for the user account with the distribution center 120. In step 101, the user signs into the website of the distribution center 120, and in step 103 the user creates an account based upon the e-mail address of the user with the distribution center 120. The account and e-mail address is used to access the electronic book. In step 105, the user receives the activation code in an e-mail and activates the account with distribution center 120 with the activation code. In step 107, the user lists the electronic books for the following semester and in step 109, the distribution center 120 determines if each of the electronic book is available or unavailable. In step 111, the available electronic books are displayed with the purchase price. In step 113, the user purchases the electronic books for a predetermined period of time such as the length of the semester. The user may view only one of the electronic books at any given time.

FIG. 2a illustrates a flow chart describing the use of the distribution center 120 website and viewing the electronic books. In step 201, the user logs into the website of the distribution center 120 and requests to view a electronic book which may be one of the purchased electronic books. In step 203, the website of the distribution center 120 determines if the semester/predetermined time period for the semester has expired, and in step 205 access to the electronic book is denied if the semester/predetermined time period has expired. If the predetermined time period/semester has not expired the website of the distribution center 120 determines if the user is currently viewing another electronic book in step 205. If the user is currently viewing another electronic book, in step 207, the website of the distribution center 120 denies access to the second electronic book. If the user is not currently viewing another electronic book, in step 207 the user selects a electronic book to be viewed. In step 209, the website of the distribution center 120 determines if the selected electronic book is on the list of the user, and in step 211, access is denied if the electronic book is not on the list.

In step 213, the website of the distribution center 120 determines if all the purchased electronic books of the selected electronic book of the user is being viewed by other users. In FIG. 2c and step 215 the website of the distribution center 120 purchases another electronic book from the vendor if all of the purchased electronic books of the selected electronic book of the user are currently being viewed by other users. Control passes to step 217, FIG. 2b where access to the electronic book allows the user to view the electronic book. In step 219, the inactivity time of the user is measured by the distribution center 120 to determine if the inactivity time has exceeded a predetermined inactivity time period. If the predetermined inactivity time period has been exceeded in step 221, access is denied to the user by the distribution center 120. If the predetermined inactivity time period has not been exceeded, then the user is allowed to continue to access to the electronic book in step 223.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A distribution system for viewing an electronic book, comprising:
a content provider to obtain and provide the electronic book;
a distribution center to distribute the electronic book from the content provider;
a predetermined number of home centers to view the electronic book by a predetermined number of users;
wherein n is the number of simultaneous users viewing a single electronic book; and
wherein no more than n is the number of purchased electronic books from the content provider.

2) A distribution system for viewing an electronic book as in claim 1, wherein the number of users registered to view the electronic book is greater than n.

3) A distribution system for viewing an electronic book as in claim 1, wherein if the user view the electronic book for more than a predetermined period of time than that user is inactivated from viewing the electronic book.

4) A distribution system for viewing an electronic book as in claim 1, wherein the user views the electronic book at the content provider.

5) A distribution system for viewing an electronic book as in claim 1, wherein the electronic book is downloaded to a server of the distribution center to be viewed by the user.

6) A distribution method for viewing an electronic book, comprising the steps of:
obtaining and providing the electronic book;
distributing the electronic book from the content provider;
viewing the electronic book by a predetermined number of users;
wherein n is the number of simultaneous users viewing a single electronic book; and
wherein no more than n is the number of purchased electronic books from the content provider.

7) A distribution method for viewing an electronic book as in claim 6, wherein the number of users registered to view the electronic book is greater than n.

8) A distribution method for viewing an electronic book as in claim 6, wherein if the user viewing the electronic book remained idle for more than a predetermined period of time than that user is inactivated from viewing the electronic book.

9) A distribution method for viewing an electronic book as in claim 8, wherein the user views the electronic book at a content provider.

10) A distribution method for viewing an electronic book as in claim 1, wherein the electronic book is downloaded to a server of a distribution center to be viewed by the user.
